(19) United States
(12) Patent Application Publication
(10) Pub. No.: US 2020/0293361 A1
(43) Pub. Date: Sep. 17, 2020

(54) METHOD AND DISTRIBUTED DATABASE SYSTEM FOR COMPUTER-AIDED EXECUTION OF A PROGRAM CODE

(71) Applicant: Siemens Aktiengesellschaft, München (DE)

(72) Inventor: Rainer Falk, Poing (DE)

(21) Appl. No.: 16/650,053

(22) PCT Filed: Sep. 25, 2018
(86) PCT No.: PCT/EP2018/075868

§ 371 Date: Mar. 24, 2020

(30) Foreign Application Priority Data
Sep. 27, 2017 (EP) 17193502.6

(51) Int. Cl. G06F 9/46; G06F 9/30; G06F 9/38; G06F 16/182; H04L 9/06

(52) U.S. Cl. CPC G06F 9/466; G06F 9/30043; H04L 2209/38; G06F 16/182; H04L 9/0643; G06F 9/3836

(57) ABSTRACT

A method by means of which it is possible, for example, to react to a smart contract of a block chain which is incorrectly programmed and to cancel if required, is provided. Furthermore, conventional operating systems and cloud-based operating systems can also be improved to improve the execution of a smart contract/(first) program code. As a result, processes in particular block chain smart contracts, operating system processes, cloud applications, are significantly better carried out and controlled.

### CROSS-REFERENCE TO RELATED APPLICATIONS

This application claims priority to PCT Application No. PCT/EP2018/075868, having a filing date of Sep. 25, 2018, which is based on European Application No. 17193502.6, having a filing date of Sep. 27, 2017, the entire contents both of which are hereby incorporated by reference.

### FIELD OF TECHNOLOGY

The following relates to a method and to a distributed database system for the computer-assisted execution of a program code.

### BACKGROUND

Blockchain technology or distributed ledger technology is a technology that is currently subject to intense discussion, and may in particular be implemented in the form of a distributed database. In addition to applications for decentralized payment systems (for example Bitcoin), new application possibilities are being developed in the financial industry. Transactions are thereby in particular able to be performed between companies in a manner protected against manipulation, without brokers or clearing points. This allows new business models without a trusted broker, it reduces transaction costs, and new digital services are able to be offered in a flexible manner without an infrastructure specifically configured for this purpose and trust relationships having to be set up. A transaction dataset (or transaction for short) protected by a blockchain comprises or references for example program code, which may also be referred to as what is known as a “smart contract”.

### SUMMARY

An aspect relates to a method and distributed database for the computer-assisted execution of a program code.

According to a first aspect, embodiments of the invention relates to a method for the computer-assisted execution of a first program code, having the following method steps:
storing a control program code in a control transaction, wherein
   the control transaction is stored in a second data block of a distributed database,
   the control program code comprises control functions for controlling the first program code,
   the control program code is executed by the distributed database;
assigning the first program code to the control program;
executing the first program code by way of the distributed database and the control program code of the second data block,
   wherein the execution is performed in particular by a multiplicity of nodes of the distributed database.

Unless specified otherwise in the following description, the terms “perform”, “calculate”, “computer-assisted”, “compute”, “establish”, “generate”, “configure”, “reconstruct”, and the like preferably relate to operations and/or processes and/or processing steps that change and/or generate data and/or convert the data into other data, wherein the data may be represented or be present in particular in the form of physical variables, for example in the form of electrical impulses. The expression “computer” should in particular be interpreted as broadly as possible in order in particular to cover all electronic devices having data processing properties. Computers may thus for example be personal computers, servers, programmable logic controllers (PLCs), hand-held computer systems, pocket PC devices, mobile radio devices and other communication devices able to process data in a computer-assisted manner, processors and other electronic data processing devices.

“Computer-assisted” in connection with embodiments of the invention may be understood to mean for example an implementation of the method in which in particular a processor executes at least one method step of the method.

A processor in connection with embodiments of the invention may be understood to mean for example a machine or an electronic circuit. A processor may be in particular a main processor (central processing unit, CPU), a microprocessor or a microcontroller, for example an application-specific integrated circuit or a digital signal processor, possibly in combination with a storage unit for storing program commands, etc. A processor may also be for example an IC (integrated circuit), in particular an FPGA (field-programmable gate array) or an ASIC (application-specific integrated circuit), or a DSP (digital signal processor) or a graphics processor GPU (graphic processing unit). A processor may also be understood to mean a virtualized processor, a virtual machine or a soft CPU. It may also be for example a programmable processor that is equipped with configuration steps for executing the method according to embodiments of the invention or is configured by way of configuration steps such that the programmable processor implements the features according to embodiments of the invention of the method, the component, the modules or other aspects and/or partial aspects of embodiments of the invention.

A “storage unit” or “storage module” and the like in connection with embodiments of the invention may be understood to mean for example a volatile memory in the form of working memory (random access memory, RAM) or a permanent memory such as a hard disk or a data carrier.

A “module” in connection with embodiments of the invention may be understood to mean for example a processor and/or a storage unit for storing program commands. By way of example, the processor is specifically configured so as to execute the program commands such that the processor executes functions in order to implement or perform the method according to embodiments of the invention or a step of the method according to embodiments of the invention.

“Provide” in connection with embodiments of the invention may be understood to mean for example loading or storing, for example of a transaction containing corresponding data. This may be performed for example on or from a storage module. “Provide” may also be understood to mean for example transmission (or sending or conveying) of corresponding data from one node to another node of the blockchain or of the distributed database (or its infrastructure).

“Control functions” in connection with embodiments of the invention may be understood to mean in particular operating system commands.

“Smart contract process” in connection with embodiments of the invention may be understood to mean in particular execution of a program code (for example of the first program code) in a process (for example of an operating system) by the distributed database or its infrastructure.

A “checksum”, for example the data block checksum, a data checksum, a transaction checksum, a chaining checksum or the like, in connection with embodiments of the invention may be understood to mean for example a cryptographic checksum or cryptographic hash or hash value that is formed or calculated in particular by way of a cryptographic hash function from a dataset and/or data and/or one of the transactions and/or a subregion of a data block (for example the block header of a block of a blockchain or data block header of a data block of the distributed database). A checksum may in particular be a checksum or checksums or hash value or hash values of a hash tree (for example Merkle tree, Patricia tree). It may also be understood to mean in particular a digital signature or a cryptographic message authentication code.

A “data block checksum” in connection with embodiments of the invention may be understood to mean a checksum that is calculated for example from some or all of the transactions of a data block. A node may then for example check/establish the integrity/authenticity of the corresponding part of a data block by way of the data block checksum. In addition or as an alternative, the data block checksum may in particular also have been formed from transactions of a preceding data block/predecessor data block of the data block. The data block checksum may in this case in particular also be formed by way of a hash tree, for example a Merkle tree [1] or a Patricia tree, wherein the data block checksum is in particular the root checksum of the Merkle tree or of a Patricia tree or of a binary hash tree. Transactions are in particular secured by way of further checksums from the Merkle tree or Patricia tree (for example using the transaction checksums), wherein the further checksums are in particular leaves in the Merkle tree or Patricia tree. The data block checksum may therefore for example secure the transactions by forming the root checksum from the further checksums. The data block checksum may in particular be calculated for transactions of a particular data block of the data blocks. Such a data block checksum may in particular be incorporated into a following data block of the particular data block in order to chain this following data block for example to its preceding data blocks (for example the first data block) and in particular thereby to allow the integrity of the distributed database to be checked. As a result, the data block checksum may for example take on the function of the chaining checksum or be incorporated into the chaining checksum.

“Transaction checksum” in connection with embodiments of the invention may be understood to mean a checksum that is formed in particular from a transaction of a data block. Calculation of a data block checksum for a corresponding data block may additionally for example be sped up, since for this purpose previously calculated transaction checksums may for example be used in the same way as leaves, for example of a Merkle tree.

A “chaining checksum” in connection with embodiments of the invention may be understood to mean a checksum that in particular specifies or references the preceding data block of the distributed database for a respective data block of the distributed database (in particular commonly referred to in the jargon as “previous block hash”) [1]. A transaction checksum or the data block checksum of a data block may for example be used as chaining checksum in order to chain a new data block to a data block of the distributed database. It is however also possible for example for a checksum to be formed from a header of the preceding data block or from the entire preceding data block and to be used as chaining checksum. This may also for example be calculated for several or all of the preceding data blocks. It may also for example be the case that the chaining checksum is formed from the header of a data block and the data block checksum. A respective data block of the distributed database however preferably in each case comprises a chaining checksum that was calculated for a previous data block of the respective data block.

The data that are stored for example in a transaction of a data block may in particular be created in different ways. Instead of the data, for example user data such as measured data or data/ownership structures of assets, a transaction of a data block may for example comprise only the checksum for these data. The corresponding checksum may in this case be created in different ways. This may be for example a corresponding data block checksum of a data block (containing the corresponding data) of another database or of the distributed database, a transaction checksum of a data block containing the corresponding data (of the distributed database or another database) or a data checksum that was formed from the data.

The corresponding transaction may additionally also comprise a reference or a specification of a memory location (for example an address of a file server and specifications as to where the corresponding data may be found on the file server, an address or another distributed database that contains the data). The corresponding data could then also for example be provided in a further transaction of a further data block of the distributed database (for example if the corresponding data and the associated checksums are contained in different data blocks). It is also however for example conceivable for these data to be provided via another communication channel.

In addition to the checksum, an additional dataset (for example a reference or a specification of a memory location) may also for example be stored in the corresponding transactions, this in particular specifying a memory location from which the data may be retrieved. This is advantageous in order in particular to keep a data size of the blockchain as small as possible.

“Security-protected” in connection with embodiments of the invention may be understood to mean for example protection that is provided in particular by way of a cryptographic method. By way of example, this may be achieved by using the distributed database to provide or transmit or send the corresponding data. This is preferably achieved by combining the various (cryptographic) checksums by these interacting in particular synergistically in order for example to improve the security or the cryptographic security for the data in the transactions. In other words, “security-protected” in connection with embodiments of the invention may in particular also be understood to mean “cryptographically protected” and/or “protected against manipulation”.

“Chaining (the) data blocks of a distributed database” in connection with embodiments of the invention may be understood to mean for example that data blocks each contain information (for example chaining checksum) that indicates another data block or a plurality of other data blocks of the distributed database or references same [1].

“Insertion into the distributed database” and the like in connection with embodiments of the invention may be understood to mean for example that in particular a transaction or the transactions or a data block containing its transactions is/are transmitted to one or more nodes of a distributed database. If these transactions are for example validated successfully (for example by the node or nodes), these transactions are in particular chained to at least one existing data block of the distributed database [1] in the form of a new data block. This validation and/or chaining may in particular be performed by a trusted node (for example a mining node, a blockchain oracle or a blockchain platform). A blockchain platform may in this case in particular be understood to mean a blockchain as a service, as is proposed in particular by Microsoft or IBM. A trusted node and/or a node may in particular in each case store a node checksum (for example a digital signature) in a data block (for example in the data block that it validates and generates, which is then chained), in order in particular to make it possible to identify the creator of the data block and/or to make it possible to identify the node. In this case, this node checksum specifies which node for example chained the corresponding data block to at least one other data block of the distributed database.

“Transaction” or “transactions” in connection with embodiments of the invention may be understood to mean for example a smart contract, a data structure or a transaction dataset that in particular in each case comprises one of the transactions or a plurality of transactions. “Transaction” or “transactions” in connection with embodiments of the invention may also be understood to mean for example the data of a transaction of a data block of a blockchain. A transaction may in particular comprise a program code that for example implements a smart contract. By way of example, in connection with embodiments of the invention, transaction may also be understood to mean a control transaction and/or command transaction and/or an assignment transaction. As an alternative or in addition, a transaction may for example be a data structure that stores data (for example the control commands and/or contractual data and/or other data such as video data, user data, measured data, etc.).

“Storing transactions in data blocks” and the like should in particular be understood to mean direct storage or indirect storage. Direct storage may in this case be understood to mean for example that the corresponding data block or the corresponding transaction contains the respective data. Indirect storage may in this case be understood to mean for example that the corresponding data block or the corresponding transaction comprises a checksum and optionally an additional dataset (for example a reference or a specification of a memory location) and the data are thus not stored directly.

A “program code” in connection with embodiments of the invention may be understood to mean for example one or more program commands that are stored in particular in one or more transactions. The program code is in particular executable and is executed for example by the distributed database. This may be performed for example by way of an execution environment (for example a virtual machine), wherein the execution environment or the program code is preferably Turing-complete. The program code is preferably executed by the infrastructure of the distributed database [4] [5]. In this case, a virtual machine is for example implemented by the infrastructure of the distributed database system of the distributed database.

A “smart contract” in connection with embodiments of the invention may be understood to mean for example an executable program code. A program code may accordingly for example be a smart contract that is executed by the distributed database (for example a blockchain or a distributed ledger).

“Proof of work” in connection with embodiments of the invention may be understood to mean for example the solving of a computationally intensive task that needs to be solved in particular depending on the data block content/content of a particular transaction [1]. Such a computationally intensive task is also referred to for example as a cryptographic puzzle.

A “distributed database” in connection with embodiments of the invention may be understood to mean for example a database distributed in a decentralized manner, a blockchain or a peer-to-peer database. If for example a blockchain is used, then this may in particular be implemented by way of a Bitcoin-based implementation or an Ethereum-based implementation.

A “distributed database system”, which may also be referred to for example as a distributed database, in connection with embodiments of the invention may also be understood to mean for example a database distributed in a decentralized manner, a blockchain, a distributed ledger, a distributed storage system, a distributed ledger technology (DLT)-based system (DLTS), a revision-proof database system, a cloud, a cloud service, a blockchain in a cloud or a peer-to-peer database. Different implementations of a blockchain or of a DLTS may also for example be used, such as for example a blockchain or a DLTS that is implemented by way of a directed acyclic graph (DAG), a cryptographic puzzle, a hash graph or a combination of the implementation variants [6] [7]. Different consensus methods (consensus algorithms) may also for example be implemented. This may be for example a consensus method using a cryptographic puzzle, gossip about gossip, virtual voting or a combination of the methods (for example gossip about gossip in combination with virtual voting) [6] [7]. If for example a blockchain is used, then this may in particular be implemented by way of a Bitcoin-based implementation or an Ethereum-based implementation [1] [4] [5]. A “distributed database system” may also be understood to mean for example a distributed database system, at least some of the nodes and/or devices and/or infrastructure of which are implemented by a cloud. By way of example, the corresponding components may be implemented in the form of nodes/devices in the cloud (for example in the form of virtual nodes in a virtual machine). This may be achieved for example using VM-ware, Amazon Web Services or Microsoft Azure. Due to the high flexibility of the explained implementation variants, partial aspects of the implementation variants may also in particular be combined with one another, for example by using a hash graph as a blockchain, wherein the blockchain itself may also for example be blockless.

If for example a directed acyclic graph (DAG) is used (for example IOTA or Tangle), transactions or blocks or nodes of the graph are in particular connected to one another via directed edges. This in particular means that (all of the) edges (always) have the same direction, similarly to in the case of time for example. In other words, it is in particular not possible to run or jump backwards (that is to say counter to the same common direction) through the transactions or the blocks or the nodes of the graph. Acyclic in this case in particular means that there are no loops when running through the graph.

The distributed database system may be for example a public distributed database system (for example a public blockchain) or a closed (or private) distributed database system (for example a private blockchain).

If it is for example a public distributed database system, this means that new nodes and/or devices are able to join or be accepted by the distributed database system without proof of authorization or without authentication or without registration information or without credentials. In such a case, the operators of the nodes and/or devices may in particular remain anonymous.

If the distributed database system is for example a closed distributed database system, new nodes and/or devices for example require a valid proof of authorization and/or valid authentication information and/or valid credentials and/or valid registration information in order to be able to join or be accepted by the distributed database system.

A distributed database system may also for example be a distributed communication system for exchanging data. This may for example be a network or a peer-2-peer network.

“Data block”, which may in particular also be referred to as “block” depending on context and implementation, in connection with embodiments of the invention may be understood to mean for example a data block of a distributed database (for example a blockchain or a peer-to-peer database) that is implemented in particular in the form of a data structure and preferably in each case comprises one of the transactions or a plurality of the transactions. In one implementation, the database may for example be a blockchain and a data block may be a block of the blockchain. A data block may for example contain specifications about the size (data size in bytes) of the data block, a data block header, a transaction counter and one or more transactions [1]. The data block header may for example contain a version, a chaining checksum, a data block checksum, a timestamp, proof of work and a nonce (one-time value, random value or counter used for the proof of work) [1].

“Nonce” in connection with embodiments of the invention may be understood to mean for example a cryptographic nonce (abbreviation for “used only once” [2] or “number used once” [3]). A nonce in particular denotes individual combinations of numbers or a combination of letters that are preferably used just once in the respective context (for example transaction, data transmission).

“Preceding data blocks of a (particular) data block of the distributed database” in connection with embodiments of the invention may be understood to mean for example only that data block of the distributed database that in particular directly precedes a (particular) data block. As an alternative, “preceding data blocks of a (particular) data block of the distributed database” may in particular also be understood to mean all of the data blocks of the distributed database that precede the particular data block. As a result, the chaining checksum or the transaction checksum may in particular for example be formed only from the data block (or its transactions) directly preceding the particular data block or from all of the data blocks (or their transactions) preceding the first data block.

A “blockchain node”, “node”, “node of a distributed database” and the like in connection with embodiments of the invention may be understood to mean for example devices (for example field devices), computers, smartphones, clients or participants that perform operations with/of the distributed database (for example a blockchain) [1]. Such nodes may for example execute transactions of a distributed database or its data blocks or insert or chain new data blocks containing new transactions into the distributed database by way of new data blocks. This validation and/or chaining may in particular be performed by a trusted node (for example a mining node) or solely by trusted nodes. A trusted node is for example a node that has additional security measures (for example firewalls, access restrictions to the node or the like) in order to prevent manipulation of the node. As an alternative or in addition, a trusted node may for example store a node checksum (for example a digital signature or a certificate) in a new data block when the new data block is chained to the distributed database. As a result, it is in particular possible to provide proof that specifies that the corresponding data block was added by a particular node or that specifies its origin.

A “computer” in connection with embodiments of the invention may be understood to mean for example a computer (system), a client, a smartphone, a device or a server that are in each case arranged outside the blockchain or are not participants in the distributed database (for example the blockchain) (that is to say do not perform operations with the distributed database or only query it without however performing transactions, inserting data blocks or calculating proof of work). As an alternative, a computer may also in particular be understood to mean a node of the distributed database.

By way of embodiments of the invention, it is in particular possible to implement a decentralized infrastructure for executing transactions. By way of example, the application-specific logic of a blockchain-based solution may in this case be implemented by way of smart contracts. This is preferably a program code that is in particular executed by the blockchain infrastructure. By way of the smart contract program code, it is for example possible to define what transactions are valid. The execution of a smart contract may in this case for example be subject to a cost, that is to say for example that a payment is necessary in order to generate transactions according to a smart contract. This for example involves a cryptocurrency or a cryptographic exchange unit.

Embodiments of the invention in particular provides a management architecture (for example a management system (operating system)) for smart contract processes that are executed in a blockchain (for example processes that execute a program code, wherein the process itself is in particular executed by the distributed database or its infrastructure). As a result, elementary operating system services of a conventional operating system are also for example made available for a distributed database (for example a blockchain infrastructure).

As a result, it is in particular easily possible to supplement a smart contract (for example the first program code) with management functions that are required for orderly operation. A corresponding smart contract thereby in particular does not have to individually implement monitoring and management routines for itself.

The method is additionally advantageous in order in particular to perform a trusted execution of a smart contract (for example the first program code) through a decentralized blockchain infrastructure. Embodiments of the invention makes it possible for example to use a decentralized blockchain in order to execute a smart contract in a security-protected manner, but still to provide particular control functions for the smart contract. By way of example, the permitted control functions (for example control actions starting a process, loading or executing the first program code, etc.) for the smart contract (for example the first program code) may be defined together with the respective first program code and stored in transactions of a data block of the distributed database with this first program code. As an alternative, the permitted control functions may be stored later on (that is to say in another transaction of another data block or of the same data block that contains the first program code).

In a first embodiment of the method, the blocks are chained to one another using a cryptographic hash function.

In a further embodiment of the method, the distributed database is a blockchain and a data block is a block of the blockchain or the distributed database is a peer-to-peer database.

The method is advantageous in order in particular to achieve a database distributed in a decentralized manner in which the administrative expenditure for a central node is dispensed with.

In a further embodiment of the method, a respective control function of the control functions controls
loading and/or execution of the first program code and/or of a further program code, or
starting of at least one process that executes the first program code and/or the further program code, wherein the process is in particular executed by the distributed database, or
ending/termination of at least one process/at least of the process that executes the first program code and/or the further program code, or
assignment of authorization information to at least one process/at least the process or to files that execute the first program code and/or the further program code and/or are used thereby, or
assignment of priority information to at least one process/at least the process that executes the first program code and/or the further program code, or
assignment of priority information to the first program code or the further program code,
assignment of quotas to the respective program codes or processes, or
a control function controls a combination of the control actions.

The method is advantageous in order in particular to implement a multiplicity of control functions, so that execution of the first program code is in particular able to be monitored better and possibly also terminated. It is furthermore possible for example to execute a program code (smart contract) multiple times with different restrictions without having to adjust the program code itself.

In a further embodiment of the method, a command transaction containing a control command is stored in a third data block of the distributed database and a control command is assigned to one or more of the control functions.

The method is advantageous in order in particular to define, in a security-protected manner, which control commands are responded to in which way. This may take place for example when defining/storing the first program code, for example by jointly storing a corresponding definition in the transaction of the first program code. As an alternative, such a definition may be stored in another transaction that is stored in a data block of the distributed database. It is in this case for example advantageous for such a definition no longer to be able to be changed (that is to say manipulated) for the first program code.

In a further embodiment of the method, a/the command transaction containing a control command is stored in a third data block of the distributed database and execution of the first program code is controlled by way of the distributed database and the control program code using the control function assigned to the command.

The method is advantageous in order in particular to execute and control the first program code from any node of the distributed database in a security-protected manner.

In a further embodiment of the method, the control program code provides execution data to the first program code.

The method is advantageous in order in particular to be able to retrieve execution data (for example resource consumption, process priority etc.) when executing the first program code.

In a further embodiment of the method, the first program code is stored in a first transaction of a first data block of the distributed database in the assignment.

The method is advantageous in order in particular to execute the first program code that is stored in the distributed database. As a result, a situation is in particular achieved whereby the first program code is stored in the distributed database, preferably in a manner not able to be changed. Manipulation of the program code at a later time is thereby in particular prevented.

In a further embodiment of the method, assignment information is stored in an assignment transaction of a/the first data block of the distributed database in the assignment, wherein assignment to the control program code is performed in particular by way of the assignment information of the first program code.

The method is advantageous in order in particular to execute the first program code that is stored outside the distributed database. As a result, a situation is in particular achieved whereby the first program code is still able to be changed if for example a programming fault arises, or it is possible to reduce the memory consumption of the distributed database. The assignment information may for example comprise a reference/a specification of a memory location of the first program code and/or a checksum from the first program code. As an alternative or in addition, the assignment information may for example comprise a checksum from the control program code and/or a reference/a specification of a memory location of the control program code (for example a reference to the corresponding data block).

In a further embodiment of the method, a useful functional scope of the first program code is reduced to a predefined functional scope by the control program code.

The method is advantageous in order in particular to prevent particular programming commands or control actions when executing the first program code. By way of example, the functional scope may thereby be reduced for a particular program code that is executed in a Turing-complete execution environment/programming language. As a result, program commands/control actions such as jump commands or loops (for example for/while loops) may be prevented, for example. In one extreme case, a Turing-complete execution environment may in particular be reduced to simple arithmetic operations. As a result, the execution of the first program code may in particular be protected against unwanted use of program commands/control actions.

According to a further aspect, embodiments of the invention relates to a distributed database system for executing a first program code, having:
a first interface for storing a control program code in a control transaction, wherein
the control transaction is stored in a second data block of a distributed database,
   the control program code comprises control functions for controlling the first program code,
   the control program code is executed by the distributed database;
a second interface for assigning the first program code to the control program;
an execution environment, wherein
   the first program code is executed by way of the control program code,
   in particular a multiplicity of nodes of the distributed database system form the execution environment.

In a further embodiment of the distributed database system, the distributed database system comprises at least one further module or a plurality of further modules for performing the method according to embodiments of the invention (or one of its embodiments).

Also provided is a computer program product (non-transitory computer readable storage medium having instructions, which when executed by a processor, perform actions)containing program commands for performing the methods according to embodiments of the invention, wherein in each case one of the methods according to embodiments of the invention, all of the methods according to embodiments of the invention or a combination of the methods according to embodiments of the invention is, are able to be performed by way of the computer program product.

Additionally provided is a variant of the computer program product containing program commands for configuring a creation device, for example a 3D printer, a computer system or a manufacturing machine suitable for creating processors and/or devices, wherein the creation device is configured by way of the program commands such that the distributed database system according to embodiments of the invention is created.

Furthermore, provided is a provision device for storing and/or providing the computer program product. The provision device is for example a data carrier that stores and/or provides the computer program product. As an alternative and/or in addition, the provision device is for example a network service, a computer system, a server system, in particular a distributed computer system, a cloud-based computer system and/or virtual computer system that stores and/or provides the computer program product, preferably in the form of a data flow.

This provision is performed for example as a download in the form of a program data block and/or command data block, preferably as a file, in particular as a download file, or as a data flow, in particular as a download data flow, of the complete computer program product. This provision may however also for example be performed as a partial download that consists of several parts, and in particular is downloaded via a peer-to-peer network or provided as a data flow. Such a computer program product is read into a system for example using the provision device in the form of the data carrier and executes the program commands such that the method according to embodiments of the invention is executed on a computer or configures the creation device such that it creates the distributed database system according to embodiments of the invention.

### BRIEF DESCRIPTION

Some of the embodiments will be described in detail, with reference to the following figures, wherein like designations denote like members, wherein:

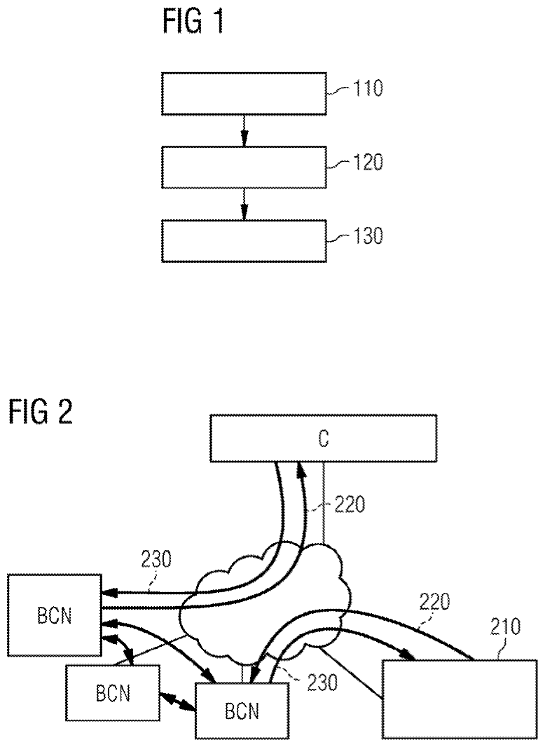

FIG. 1 shows a first exemplary embodiment of the invention in the form of a flowchart;

FIG. 2 shows a second exemplary embodiment of the invention in the form of a database system;

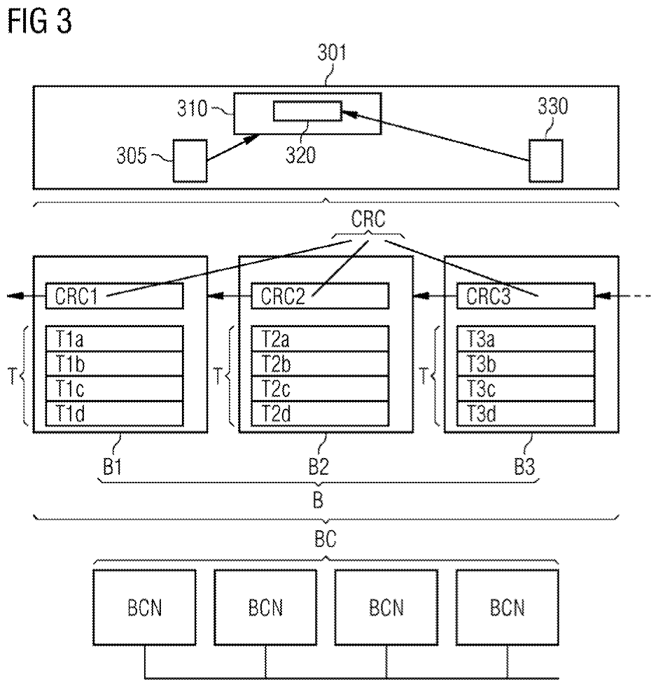

FIG. 3 shows a third exemplary embodiment of the invention in the form of a database system.

### DETAILED DESCRIPTION

The following exemplary embodiments, unless specified otherwise or already specified, have at least one processor and/or one storage unit in order to implement or execute the method.

A (relevant) person skilled in the art with knowledge of the method claim/method claims is also in particular obviously aware of all of the usual options in the conventional art for creating products or implementation options, meaning that there is in particular no need for a stand-alone disclosure in the description. These customary implementation variants known to a person skilled in the art may in particular be implemented solely by way of hardware (components) or solely by way of software (components). As an alternative and/or in addition, a person skilled in the art, within the scope of his expert knowledge, may select a wide variety of any inventive combinations of hardware (components) and software (components) in order to achieve implementation variants according to embodiments of the invention.

A combination according to embodiments of the invention of hardware (components) and software (components) may in particular arise when some of the inventive effects are brought about preferably solely by specific hardware (for example a processor in the form of an ASIC or FPGA) and/or some others are brought about by the (processor-assisted and/or memory-assisted) software.

With regard to the high number of different implementation possibilities, it is in particular impossible and also not expedient or necessary for the understanding of embodiments of the invention to cite all of these implementation possibilities. In this respect, all of the exemplary embodiments below should in particular be understood to indicate a few ways, merely in an exemplary manner, of how such implementations of the inventive teaching could in particular appear.

The features of the individual exemplary embodiments are therefore in particular not restricted to the respective exemplary embodiment, but rather relate in particular to embodiments of the invention in general. Features of one exemplary embodiment may accordingly preferably also serve as features for another exemplary embodiment, in particular without this having to be mentioned explicitly in the respective exemplary embodiment.

FIG. 1 shows a first exemplary embodiment of the invention in the form of a flowchart of the method according to embodiments of the invention for the computer-assisted execution of a first program code.

The method is preferably performed in a computer-assisted manner.

Specifically, in this exemplary embodiment, a method for the computer-assisted execution of a first program code is performed.

The method comprises a first method step of storing 110 a control program code in a control transaction, wherein the control transaction is stored in a second data block of a distributed database. The control program code additionally comprises control functions for controlling the first program code and the control program code is executed by the distributed database. The control functions are preferably able to be used by interfaces of the control program code.

The method comprises a second method step of assigning 120 the first program code to the control program. This may be achieved for example by storing the first program code in a first transaction, wherein the first transaction is stored in a first data block of the distributed database.

The control program code may in this case be created in different ways. In the simplest case, it may for example transmit a transmission of control functions for controlling the first program code to the first program code only by using the corresponding memory location/reference to the first program code and using the corresponding control function that was provided for example by a command transaction. The first program code or a separate execution environment for executing the first program code (for example a conventional operating system) then implements the corresponding control commands. In this case, the control program code may for example comprise only one control command. In such a case, a control transaction would in particular be identical to the functional scope of a command transaction that comprises for example an operating system command.

The control program code may also be used for example to provide only corresponding control actions, such that for example a conventional operating system is able to retrieve and implement them. In this case, the control program code may comprise just one control action/one control command that are retrieved independently by an operating system from the distributed database (for example using assignment information that was provided at assignment).

The control program code may however also perform complex functions by fully or partly implementing the functions of an operating system and correspondingly controlling/executing the first program code itself. In this case, the control program code may preferably implement a virtualized operating system or a virtual machine, whose functional scope can preferably be set specifically for the first program code.

The control program code may thus for example implement the functionalities of one or more operating system commands/control functions itself or forward/provide operating system commands/control functions for a conventional operating system.

The method comprises a third method step of executing 130 the first program code by way of the distributed database and the control program code, wherein the execution is performed in particular by a multiplicity of nodes of the distributed database.

The execution may in this case be performed in different ways. If for example the first program code is stored in the distributed database, then the execution may be performed by the distributed database or its infrastructure. If the execution of the first program code is controlled for example using a conventional operating system, the execution is performed by way of the distributed database and the control program code in that the corresponding control actions/control commands are provided to the conventional operating system (for example transmitted to the operating system or retrieved independently by the operating system from the distributed database).

The transactions may for example each be cryptographically protected by a transaction checksum that is preferably likewise stored in the corresponding data block or the corresponding transaction.

The data blocks are in each case preferably chained to one another by way of a chaining checksum of the corresponding preceding data block. A cryptographic hash function is preferably used for this purpose.

The distributed database is preferably implemented in the form of a blockchain and the data blocks are in particular blocks of the blockchain. The distributed database may however also be implemented in other ways. A further possibility would be a peer-to-peer database.

In order to control the execution of the first program code, a control command may for example preferably be or have been assigned to one or more of the control functions. Such an assignment may for example likewise be stored in a data block of the distributed database.

In order then to control the first program code, a command transaction containing a control command is for example stored in a third data block of the distributed database. By way of the distributed database and the control program code, execution of the first program code may be controlled using the control function assigned to the command. By way of example, starting a process that executes the first program code, stopping a process that executes the first program code, etc.

In other words, embodiments of the invention may be used to control the execution of a program code that is executed by a distributed database or its infrastructure in a secure and/or manipulation-proof manner.

By way of embodiments of the invention, management may be performed for example on the basis of the distributed data of a conventional operating system (server, cloud). As a result, the following control actions may for example be controlled/managed:
loading of apps/containers
starting of processes/containers
ending of processes/containers (kill)
allocation of authorization information of a process or of files
allocation of priority information (Unix nice parameter)
assignment of quotas to processes/containers

For this purpose, respective command transactions (operating system commands) in the form of a transaction are for example set into a blockchain. These are evaluated by an operating system and executed if the transaction (for example command transactions and/or control transactions) containing their commands (for example control program code or control functions, operating system commands) is valid (for example by the control program code providing this information in a corresponding manner). The validity of the corresponding transaction or the commands may then for example be established from the transaction checksum and/or data block checksum (for example examining the digital signature of the transaction creator and checking whether it is authorized to execute such a command).

A decentralized administration is furthermore thereby able to be achieved easily without a user or administrator having to log onto the system managed by the blockchain.

The operating system furthermore provides operative data (process list, processor load, memory consumption) as a transaction in a blockchain. A corresponding smart contract is thereby automatically able to evaluate the data and respond thereto in a suitable manner (for example end process).

This is advantageous in particular when server/cloud services are hosted. A user may then control and monitor the services that are used via a blockchain.

A process/container may furthermore possibly be started easily and flexibly in a cloud environment since it is not necessary to set up any administration access to the cloud system. Cloud services may be invoiced via the blockchain. Flexible deployment of apps/containers in a distributed infrastructure is thereby made possible, since users/administrators do not require a user account on the target systems and have to register there (login shell).

Embodiments of the invention makes it possible in particular also to implement an operating system for the controlled execution of the first program code (for example a smart contract) on the basis of the distributed database. In this case, the control program code implements the functionalities of the operating system itself, instead of providing corresponding operating system commands (for example control commands, control functions) to a conventional operating system.

According to embodiments of the invention, a distributed operating system (also referred to as SCOS or smart contract operating system) based on a blockchain is in particular proposed. It is implemented for example in the form of control program code (for example a smart contract that comprises the control program code) for a blockchain platform. The operating system may be instantiated, that is to say activated in the blockchain platform and executed in the blockchain.

The distributed operating system controls the execution of program codes (also referred to as SC process, SCP), for example the first program code, which may also be implemented in the form of a smart contract. A smart contract process SCP (that is to say a process that executes the first program code) may for this purpose be assigned to an SCOS entity. This may be achieved for example in that a smart contract process, executed under SCOS control, accesses process management data assigned to the SCP. That is to say, the smart contract process management data are updated depending on the execution of the smart contract process. In this case, smart contract process management data are for example:
resource consumption (spent cryptocurrency) of an SCP
number (absolute number of transactions) or rate (transactions per hour) that an SCP is able to generate.

A smart contract process may in this case be managed individually by the distributed operating system. It is however also possible to combine a plurality of smart contract processes (that execute the first program code multiple times or execute different program codes) to form a group and to record the management data for the group of the plurality of smart contract processes or to end the processes.

As a result, a plurality of smart contract processes of a user may for example be combined to form a resource group and monitored jointly. That is to say, the group of smart contract processes share common smart contract process management data.

The distributed operating system thus in particular creates a watchdog in the form of a smart contract that runs in the blockchain and monitors one (or more) other smart contracts (for example first program codes). This may also be understood in particular to be a smart contract quota manager, since a smart contract process is only able to consume blockchain resources (for example Bitcoins) in accordance with the assigned quota.

The monitored smart contract is active only as long as the corresponding kill transaction that is set for example into the blockchain by a command transaction is not active, or as long as no current suspend transaction (likewise a command transaction that comprises the suspend command as control command) is present. In this case, a suspend transaction may in particular be undone again by an unsuspend transaction.

A kill/suspend transaction may for example be generated automatically when a smart contract process infringes predefined criteria (exceedance of resource consumption) or manually by a kill transaction set by an administrator.

Administrative management transactions may furthermore be set into the blockchain.

A smart contract process is ended, that is to say it is no longer able to generate any further transactions, depending on the set management transactions. This has the advantage that a smart contract is able to be ended administratively by setting a kill transaction. The ended smart contract is then no longer able to generate any further transactions.

A smart contract process may furthermore be assigned an additional budget (quota) that it is able to consume (for example Bitcoins) by way of a management transaction. A smart contract (that is to say the first program code) reduces the quota assigned thereto when it is executed. A new transaction may be generated by the smart contract process only when the quota assigned thereto is positive. As a result, a user is able to control how many of his resources available to him are able to be consumed by a particular smart contract.

The credit account of a user being consumed completely by a defective smart contract in the event of a programming fault is furthermore for example prevented.

If a smart contract process has consumed the allocated resources (quota), it may for example be stopped—for example through a suspend transaction. The smart contract process is stopped until resources are allocated again - for example by an unsuspend transaction that is controlled by a smart contract in the event of sufficient presence of a corresponding credit (for example Bitcoins). In another variant, the smart contract process is ended (kill). For this purpose, a kill transaction for the smart contract process in question may be generated automatically and set into the blockchain.

FIG. 2 shows one exemplary embodiment of the invention. Specifically, a management system (operating system) for smart contract processes that are executed in a blockchain is provided. As a result, elementary operating system services of a conventional operating system are also made available for a blockchain infrastructure.

A smart contract (for example the first program code) may thereby easily be supplemented with management functions that are necessary for orderly operation. A smart contract thereby in particular does not have to implement monitoring and management routines individually for itself.

FIG. 2 shows an exemplary system having a plurality of blockchain nodes BCN that form a blockchain (for example Bitcoin nodes, hyperledger nodes or Ethereum nodes). The arrows represent possible information flows. Since a blockchain is a decentralized, distributed database, it is possible for example to communicate with one of the multiplicity of identical blockchain nodes BCN.

According to embodiments of the invention, a cloud platform C is managed by the blockchain: a management station 210 (for example operated by an administrator) for this purpose sets a control transaction 220 in order for example to start a first program code (for example Apache container).

The control transaction 220 is validated in the blockchain. The cloud platform C evaluates the control transaction 220 in a block of the blockchain as a transaction confirmed as valid and starts the corresponding container or first program code. The control transaction 220 may for example comprise a unique identifier of the container (for example its URL, hash value), and quota information (for example maximum network transmission rate) and authorization information (for example a group ID under which the container should be executed).

The cloud platform C furthermore sets monitoring data, assigned to the started container, as transaction 230 (for example CPU load, memory consumption, transmission volume).

Smart contracts (smart contract processes) may accordingly also be loaded by a blockchain transaction and activated or maintained or stopped.

Management data may also be assigned to a smart contract (process) at the start and/or during the execution (quotas, authorization information). In this case, smart contract processes themselves may be monitored and controlled by a smart contract of the blockchains.

FIG. 3 shows a further exemplary embodiment of the invention. FIG. 3 in this case shows a distributed database system 301 that is implemented for example by way of a blockchain BC.

Specifically, FIG. 3 shows blocks B, for example a first block B1, a second block B2 and a third block B3, of the blockchain BC.

The blocks B each comprise a plurality of transactions T. The first block B1 comprises for example a first transaction T1a, a second transaction T1b, a third transaction Tlc and a fourth transaction T1d.

The second block B2 comprises for example a fifth transaction T2a, a sixth transaction T2b, a seventh transaction T2c and an eighth transaction T2d.

The third block B3 comprises for example a ninth transaction T3a, a tenth transaction T3b, an eleventh transaction T3c and a twelfth transaction T3d.

The blocks B in each case additionally also comprise one of the chaining checksums CRC that are formed depending on the direct predecessor block. The first block B1 thus comprises a first chaining checksum CRC1 from its predecessor block, the second block B2 comprises a second chaining checksum CRC2 from the first block B1, and the third block B3 comprises a third chaining checksum CRC3 from the second block B2.

The respective chaining checksum CRC1, CRC2, CRC3 is preferably formed from the block header of the corresponding predecessor block. The chaining checksums CRC may preferably be formed using a cryptographic hash function such as SHA-256, KECCAK-256 or SHA-3.

Each of the blocks may additionally comprise a data block checksum. This may be implemented for example by way of a hash tree.

In order to form the hash tree, a transaction checksum (for example likewise a hash value) is calculated for each transaction of a data (block). As an alternative or in addition, a transaction checksum that was created by the generator of the transaction, preferably when the transaction was generated, may be reused for this purpose.

A Merkle tree or Patricia tree, for example, whose root hash value/root checksum is preferably stored as a corresponding data block checksum in the respective blocks, is usually used for a hash tree.

In one variant, the data block checksum is used as a chaining checksum.

A block may furthermore have a timestamp, a digital signature, or proof of work, as was explained in the embodiments of the invention.

The blockchain itself is implemented by a blockchain infrastructure having a plurality of blockchain nodes.

The distributed database 301, which is implemented by way of the blockchain BC, additionally also comprises a first interface 305, a second interface 320 and an execution environment 310 that are connected to one another in terms of communication via the blockchain or its infrastructure.

The first interface 305 is configured so as to store a control program code in a control transaction (for example the sixth transaction T2b), wherein the control transaction is stored in a second data block (for example block B2) of the distributed database 301. In this case, the control program code comprises control functions for controlling the first program code, and the control program code is executed by the distributed database.

The second interface 330 is configured so as to assign the first program code to the control program. This may be achieved for example by storing the first program code in the first transaction T1a of the first block B1.

The execution environment 310 (for example a virtual machine) then uses the control program code of the control transaction in order to execute the first program code using the distributed database 301. This is preferably implemented by the blockchain infrastructure, for example by a multiplicity of nodes of the distributed database system 301 forming the execution environment.

The distributed database system or its nodes (that is to say the blockchain nodes) may for example additionally also comprise a further or a plurality of further components, such as for example a processor, a storage unit, an input device, in particular a computer keyboard or a computer mouse, and a display device (for example a monitor). The processor may for example comprise a plurality of further processors that may be used in particular to implement further exemplary embodiments. The further component(s) may likewise for example be connected to one another in terms of communication via the blockchain or its infrastructure.

The processor may be for example an ASIC that has been implemented in an application-specific manner for the functions of a respective module or all of the modules of the exemplary embodiment (and/or further exemplary embodiments), wherein the program component or the program commands is/are in particular implemented in the form of an integrated circuit. The processor may also for example be an FPGA that is configured, in particular by way of the program commands, such that the FPGA performs the functions of a respective module or all of the modules of the exemplary embodiment (and/or further exemplary embodiments).

By virtue of embodiments of the invention cited in the exemplary embodiments, it is possible for example to respond to a smart contract that is programmed incorrectly and possibly to terminate it. Conventional operating systems and cloud-based operating systems (Microsoft Azure, Amazon AWS, Siemens Mindsphere) may also likewise be improved by way of embodiments of the invention in such a way as to improve execution of a smart contract/(first) program code. As a result, in particular processes (in particular blockchain smart contracts, operating system processes, cloud app) are executed in a considerably improved and considerably more controlled manner.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for the computer-assisted execution of a first program code, having the following method steps:
storing a control program code in a control transaction, wherein,
the control transaction is stored in a second data block of a distributed database,
the control program code comprises control functions for controlling the first program code.
the control program code is executed by the distributed database;
assigning the first program code to the control program;
executing the first program code by way of the distributed database and the control program code,
wherein the executing is performed by a multiplicity of nodes of the distributed database.

2. The method as claimed in claim 1, wherein the data blocks are chained to one another using a cryptographic hash function.

3. The method as claimed in claim 1, wherein,
the distributed database is a blockchain and a data block is a block of the blockchain. or
the distributed database is a peer-to-peer database.

4. The method as claimed in claim 1, wherein a respective control function of the control functions:
controls loading and/or execution of the first program code and/or of a further program code, or
controls starting of at least one process that executes the first program code and/or the further program code, wherein the process is in particular executed by the distributed database, or
controls ending/termination of at least one process/at least of the process that executes the first program code and/or the further program code, or
controls assignment of authorization information to at least one process/at least the process or to files that execute the first program code and/or the further program code and/or are used thereby, or
controls assignment of priority information to at least one process/at least the process that executes the first program code or the further program code, or
controls assignment of priority information to the first program code or the further program code,
controls assignment of quotas to the respective program codes or processes, or
a control function controls a combination of saklthe control actions.

5. The method as claimed in claim 1, wherein
a control command is assigned to one or more of the control functions.

6. The method as claimed in claim 4, wherein:
a command transaction containing a control command is stored in a third data block of the distributed database.
execution of the first program code is controlled by way of the distributed database and the control program code using the control function assigned to the control command.

7. The method as claimed in claim 1, wherein the control program code provides execution data to the first program code.

8. The method as claimed in claim 1, wherein the first program code is stored in a first transaction of a first data block of the distributed database in the assignment.

9. The method as claimed in claim 1, wherein assignment information is stored in an assignment transaction of a/the first data block of the distributed database in the assignment, wherein the first program code is assigned to the control program code by way of the assignment information.

10. The method as claimed in claim 1, wherein the control program code reduces a useful functional scope of the first program code to a predefined functional scope.

11. A distributed database system for executing a first program code, comprising:
a first interface for storing a control program code in a control transaction, wherein:
the control transaction is stored in a second data block of a distributed database,
the control program code comprises control functions for controlling the first program code,
the control program code is executed by the distributed database;
a second interface for assigning the first program code to the control program;
an execution environment, wherein;
the first program code is executed by way of the control program code,
in particular a multiplicity of nodes of the distributed database system form the execution environment.

12. A computer program product, comprising a computer readable hardware storage device having computer readable program code stored therein, said program code executable by a processor of a computer system to implement a method as claimed in claim 1.

13. The computer program product containing program commands for a creation device that is configured by way of the program commands so as to create the distributed database as claimed in claim 11.

14. A provision device for die computer program product as claimed in claim 12, wherein the provision device stores and/or provides the computer program product.
